(19) United States
(12) Patent Application Publication
(10) Pub. No.: US 2008/0202260 A1
(43) Pub. Date: Aug. 28, 2008

(54) SCHEDULING METHOD AND PROGRAM FOR A SUBSTRATE TREATING APPARATUS

(76) Inventor: Masahiro Yamamoto, Kyoto (JP)

Correspondence Address: OSTROLENK FABER GERB & SOFFEN, 1180 AVENUE OF THE AMERICAS, NEW YORK, NY, 100368403, US

(21) Appl. No.: 12/036,452

(22) Filed: Feb. 25, 2008

(30) Foreign Application Priority Data
Feb. 26, 2007 (JP) 2007-045571

(51) Int. Cl. G01N 1/34

(52) U.S. Cl. 73/863.01

(57) ABSTRACT

A scheduling method for a substrate treating apparatus having a plurality of treating sections for treating substrates, wherein, based on a recipe including a plurality of treating steps, a controller determines beforehand an order of treating a plurality of lots successively by operating a transport device having a substrate holder for transferring the substrates to transport the lots to the treating sections. When arranging a specific treating step that may be accompanied by dynamic processing, among the treating steps, the controller determines whether the dynamic processing should be allocated before the specific treating step, based on a treating step corresponding to an origin of transportation for a previous specific treating step and a treating step corresponding to an origin of transportation for the specific treating step.

### BACKGROUND OF THE INVENTION

(1) Field of the Invention

This invention relates to a scheduling method and program for a substrate treating apparatus that performs predetermined treatment such as cleaning and drying on semiconductor wafers or glass substrates for liquid crystal displays (which will be referred to hereinafter simply as substrates). More particularly, the invention relates to a technique for preparing a schedule in advance of such treatment.

(2) Description of the Related Art

In treating a plurality of lots with a substrate treating apparatus having a plurality of treating sections, a conventional method of this type, for example, causes a controller to determine beforehand, based on a recipe including a plurality of treating steps, an order of treating a plurality of lots successively by operating a transport device to transport the lots to the treating sections for successively treating the lots (see Japanese Unexamined Patent Publication No. 2002-341923, for example).

Such a scheduling method for the substrate treating apparatus determines, before actually starting the treatment of the lots, which lot should be treated by which treating section at which time. Thus, the lots can be arranged efficiently to realize an improved operating rate of the substrate treating apparatus.

Between different treatments, “dynamic processing” may be inserted as part of the schedule regardless of the recipe. For example, a common transport device for transporting substrates to each treating section may receive and transport substrates having undergone treatment with a treating solution such as a chemical solution, and thereafter, without any measure taken, hold substrates not yet immersed in the treating solution. Then, the treating solution adhering to a substrate holder of the transport device will adhere to the substrates, thereby exerting a harmful influence on the substrates. Therefore, after the substrate holder of the transport device contacts the treating solution, “rinsing and drying treatment” is added to the schedule as dynamic processing for rinsing and drying the substrate holder before receiving a next lot of substrates.

The conventional method noted above has the following drawback.

In the conventional scheduling method, when the substrate holder gets wet, the rinsing and drying treatment is added uniformly after a previous transporting operation and before the transport device transports a next lot of substrates. Generally, it is very rare that only one lot is treated, and a plurality of lots are usually loaded for treatment one after another. Even if the substrate holder gets wet, the rinsing and drying treatment is unnecessary, depending on other lots to be transported subsequently. In spite of this, the rinsing and drying treatment is uniformly added before transporting operations. When, for example, a first lot is received from a deionized water cleaning unit, deionized water remains adhering to the substrate holder. Even if a second lot is treated by a different deionized water cleaning unit, dynamic processing is carried out for rinsing and drying the transport device after transporting the first lot and before transporting the second lot. As a result, the unnecessary rinsing and drying treatment is included in the schedule, thereby lowering the throughput of substrate treatment.

### SUMMARY OF THE INVENTION

This invention has been made having regard to the state of the art noted above, and its object is to provide a scheduling method and program for a substrate processing apparatus, which can improve the throughput of substrate treatment by flexibly arranging dynamic processing based on a combination of consecutive treating steps.

This invention provides a scheduling method for a substrate treating apparatus having a plurality of treating sections for treating substrates, wherein, based on a recipe including a plurality of treating steps, a controller determines beforehand an order of treating a plurality of lots successively by operating a transport device having a substrate holder for transferring the substrates to transport the lots to the treating sections, the method comprising a step executed by the controller when arranging a specific treating step that may be accompanied by dynamic processing, among the treating steps, for determining whether the dynamic processing should be allocated before the specific treating step, based on a treating step corresponding to an origin of transportation for a previous specific treating step and a treating step corresponding to an origin of transportation for the specific treating step.

The controller, when arranging a specific treating step that may be accompanied by dynamic processing among treating steps, determines whether the dynamic processing should be allocated before the specific treating step, based on the combination of a treating step corresponding to the origin of transportation for the previous specific treating step and a treating step corresponding to the origin of transportation for the current specific treating step. Thus, the dynamic processing is not allocated uniformly. The dynamic processing can be allocated flexibly according to an allocating situation of treating steps for different lots. A wasteful allocation of dynamic processing is eliminated, thereby securing improved throughput of the substrate treating apparatus.

The above “specific treating step” may be a lot transporting operation by the transport device for transferring the substrates, for example. The “dynamic processing” in that case may be rinsing and drying treatment for cleaning and drying the transport device (also called chuck cleaning). Another “dynamic processing” may be a maintenance operation for returning to the origin position of the transport device, which is performed in order to maintain the accuracy of position for transportation.

In this invention, absent the previous specific treating step, the controller may refer to a state storage unit storing a final state of the substrate holder, and regard the final state of the substrate holder as the treating step corresponding to the origin of transportation for the previous specific treating step.

A proper decision can be made by referring to the storage unit, even when no previous specific treating step is included in the schedule.

The controller may allocate the dynamic processing when the treating step corresponding to the origin of transportation for the previous specific treating step is treatment with a chemical solution, and the treating step corresponding to the origin of transportation for the specific treating step is one of rinsing treatment of the substrates with deionized water, rinsing and drying treatment of the substrates, and loading or unloading of the substrates.

By carrying out the dynamic processing in the case of such combination of treating steps, the substrates are made secure against a harmful influence of the chemical solution.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a plan view showing an outline of a substrate treating apparatus according to this invention;

FIG. 2 is a block diagram showing an outline of the substrate treating apparatus;

FIG. 3 is a table showing combinations of consecutive treating steps and necessity of dynamic processing;

FIG. 4 is a flow chart of operation;

FIG. 5 is a time chart showing a scheduling stage;

FIG. 6 is a time chart showing a scheduling stage;

FIG. 7 is a time chart showing a scheduling stage; and

FIG. 8 is a time chart showing a scheduling stage.

### DESCRIPTION OF THE PREFERRED EMBODIMENTS

A preferred embodiment of this invention will be described in detail hereinafter with reference to the drawings.

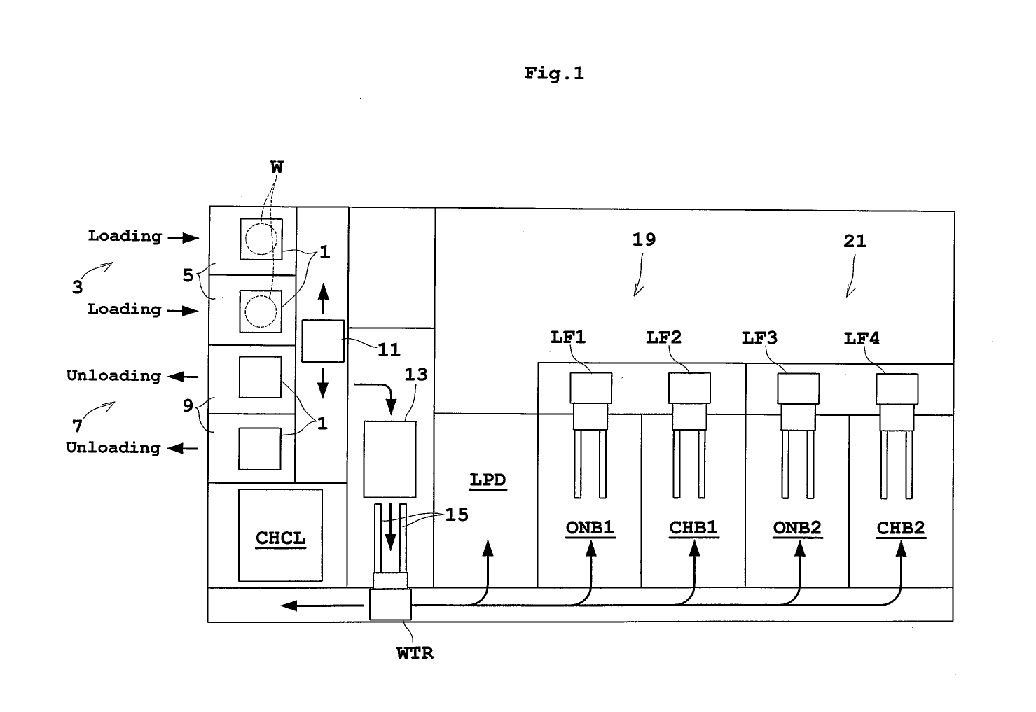

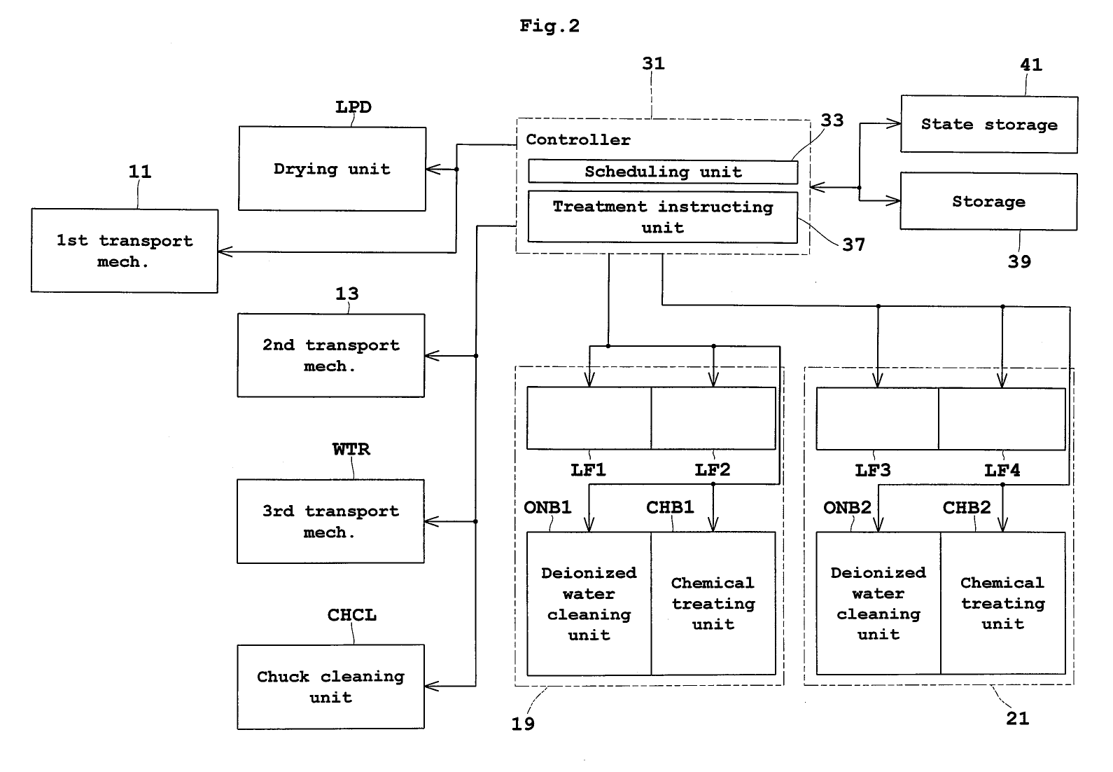

FIG. 1 is a plan view showing an outline of a substrate treating apparatus according to this invention. FIG. 2 is a block diagram showing an outline of the substrate treating apparatus.

This substrate treating apparatus performs chemical treatment, cleaning treatment and drying treatment of wafers W, for example. A plurality of (e.g. 25) wafers W are stored in vertical posture in each cassette 1. Cassettes 1 containing wafers W to be treated are placed in a loading section 3. The loading section 3 includes two support tables 5 for receiving the cassettes 1. An unloading section 7 is disposed adjacent the loading section 3. The unloading section 7 is used for delivering treated wafers W as stored in cassettes 1. As does the loading section 3, the unloading section 7 having the above function includes two support tables 9 for receiving the cassettes 1.

In an area extending along the loading section 3 and unloading section 7 is a first transport mechanism 11 movable between these sections. The first transport mechanism 11 fetches a plurality of wafers W from each cassette 1 placed on the table 5 and transports the wafers W to a second transport mechanism 13.

The second transport mechanism 13 transports the wafers W to a third transport mechanism WTR. The second transport mechanism 13 also receives treated wafers W from the third transport mechanism WTR, and transports these wafers W to the first transport mechanism 11. The third transport mechanism WTR is constructed movable longitudinally of the substrate treating apparatus, and includes a chuck 15 for holding a plurality of wafers W.

The third transport mechanism WTR corresponds to the transport device in this invention. The chuck 15 corresponds to the substrate holder in this invention.

A drying unit LPD is disposed in the most upstream position with respect to the direction of movement of the third transport mechanism WTR, for drying a plurality of wafers W placed in a low-pressure chamber.

A first treating section 19 is disposed next to the drying unit 17 in the direction of movement of the third transport mechanism WTR.

The first treating section 19 includes a deionized water cleaning unit ONB1 for cleaning a plurality of wafers W with deionized water, and a chemical treating unit CHB1 for performing chemical treatment of the wafers W with a treating solution. The deionized water cleaning unit ONB1 has a lifter LF1 for transferring the wafers W to and from the third transport mechanism WTR. The lifter LF1 is vertically movable between a treating position inside the deionized water cleaning unit ONB1 and a transfer position above the cleaning unit ONB1. Similarly, the chemical treating unit CHB1 has a lifter LF2.

A second treating section 21 is disposed adjacent the first treating section 19. The second treating section 21 has the same construction as the first treating section 19. That is, the second treating section 21 includes a deionized water cleaning unit ONB2, a chemical treating unit CHB2 and lifters LF3 and LF4.

A chuck cleaning unit CHCL is disposed adjacent the support tables 9. The chuck cleaning unit CHCL has functions to clean the chuck 15 of the third transport mechanism WTR with deionized water or the like, and thereafter to dry the chuck 15.

The substrate treating apparatus having the above construction is controlled overall by a controller 31 as shown in the block diagram of FIG. 2.

The controller 37 includes a CPU and the like, a scheduling unit 33 and a treatment instructing unit 37. A storage unit 39 connected to the controller 31 stores recipes prepared beforehand by the user of this substrate treating apparatus and each including a plurality of treating steps specifying how substrates should be treated, a schedule preparation program, and a processing program for executing the schedule prepared. The storage unit 39 stores also a table showing combinations of consecutive treating steps and necessity of dynamic processing (details will be described hereinafter).

The scheduling unit 33 handles the plurality of wafers W stored in each cassette 1 placed in the loading section 3 as one lot, and prepares a schedule to allocate treating steps for each lot efficiently in time series, before actually starting treatment, according to a recipe designated by the operator of the apparatus and stored in the storage unit 39.

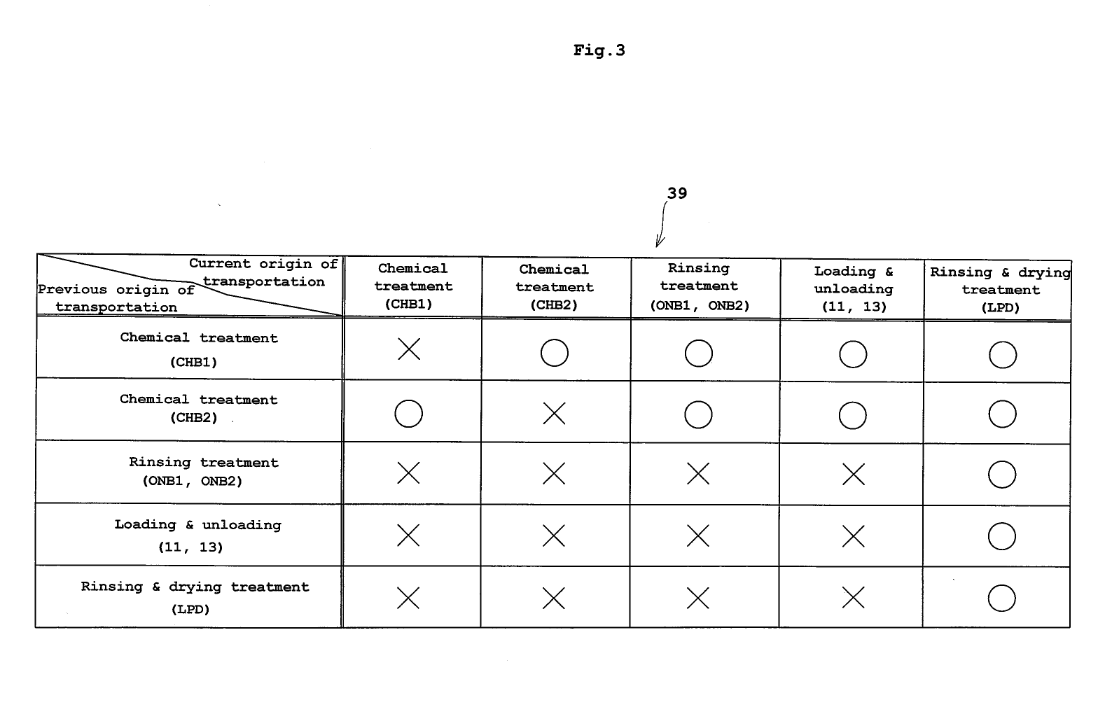

In preparing the schedule, the scheduling unit 33 refers to the table stored in the storage unit 39. Based on this table, the scheduling unit 33, in allocating a specific treating step that may be accompanied by dynamic processing, e.g. a transporting step executed by the third transport mechanism WTR, determines whether or not the rinsing and drying of the chuck 15 which is the “dynamic processing” should be allocated before the transporting step. An example of the table is shown in FIG. 3. This table shows combinations of treating steps immediately preceding transporting operations of the third transport mechanism WTR already allocated (“origin of transportation for the previous specific treating step” in this invention), and treatments immediately preceding transporting operations of the third transport mechanism WTR yet to be allocated (“origin of transportation for the (current) specific treating step” in this invention). The table also shows whether or not each combination requires the rinsing and drying treatment of the chuck 15 in the chuck cleaning unit CHCL (“dynamic processing” in this invention). In FIG. 3, “O” indicates that this processing is necessary, and “X” indicates it is unnecessary.

Specifically, the rinsing and drying treatment of the chuck 15 is carried out whenever the origin of transportation for the previous specific treating step is “chemical treatment” by the chemical treating unit CHB1, and the origin of transportation for the current specific treating step is “chemical treatment” by the chemical treating unit CHB2, “rinsing treatment” by the deionized water cleaning unit ONB1 or ONB2, “loading and unloading” by the first transport mechanism 11 or second transport mechanism 13, or “rinsing and drying treatment” by the drying unit LPD. After receiving the wafers W having undergone the chemical treatment, the chemical solution remains on the chuck 15. The rinsing and drying treatment is carried out in order to avoid a harmful influence of the chemical solution exerted on other wafers W to be received by the chuck 15.

The rinsing and drying treatment of the chuck 15 is carried out also when the origin of transportation for the previous specific treating step is “chemical treatment” by the chemical treating unit CHB2, and the origin of transportation for the current specific treating step is “chemical treatment” by the chemical treating unit CHB1, “rinsing treatment” by the deionized water cleaning unit ONB1 or ONB2, “loading and unloading” by the first transport mechanism 11 or second transport mechanism 13, or “rinsing and drying treatment” by the drying unit LPD.

When the origin of transportation for the previous specific treating step is “rinsing treatment” by the deionized water cleaning unit ONB1 or ONB2, the rinsing and drying treatment of the chuck 15 is carried out only if the origin of transportation for the current specific treating step is “rinsing and drying treatment” by the drying unit LPD. This avoids the inconvenience of rinsed and dried wafers W being wetted again by the deionized water adhering to the chuck 15 having transported rinsed wafers W.

When the origin of transportation for the previous specific treating step is “loading and unloading” by the first transport mechanism 11 or second transport mechanism 13 or “rinsing treatment” by the deionized water cleaning unit ONB1 or ONB2, the rinsing and drying treatment of the chuck 15 is carried out likewise only if the origin of transportation for the current specific treating step is “rinsing and drying treatment” by the drying unit LPD.

The controller 31 has a state storage unit 41 connected thereto. The state storage unit 41 stores a final state of the chuck 15 of the third transport mechanism WTR. Specifically, the state storage unit 41 stores a final treating step corresponding to the origin of transportation by the third transport mechanism WTR before a start of scheduling.

The treatment instructing unit 37 instructs operations of the treating units to be carried out at proper times, based on the schedule prepared by the scheduling unit 33 and stored in the storage unit 39.

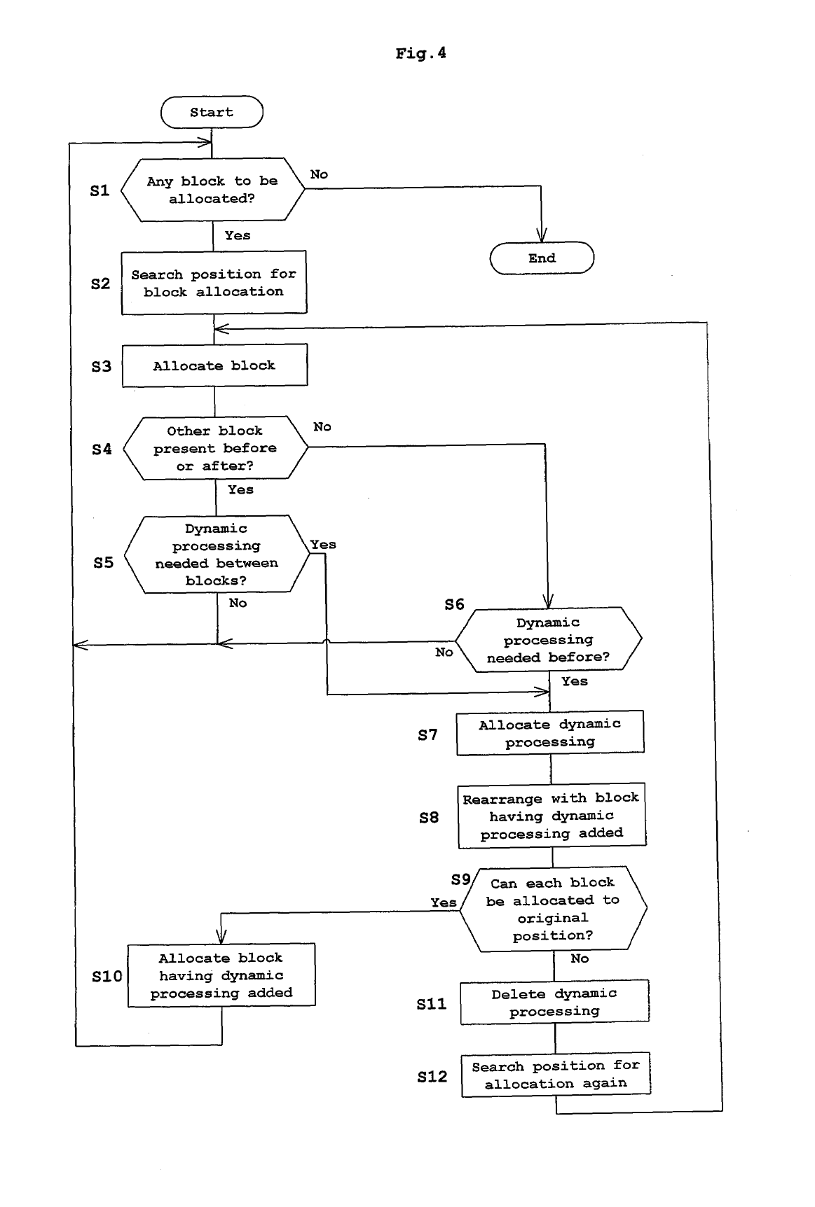

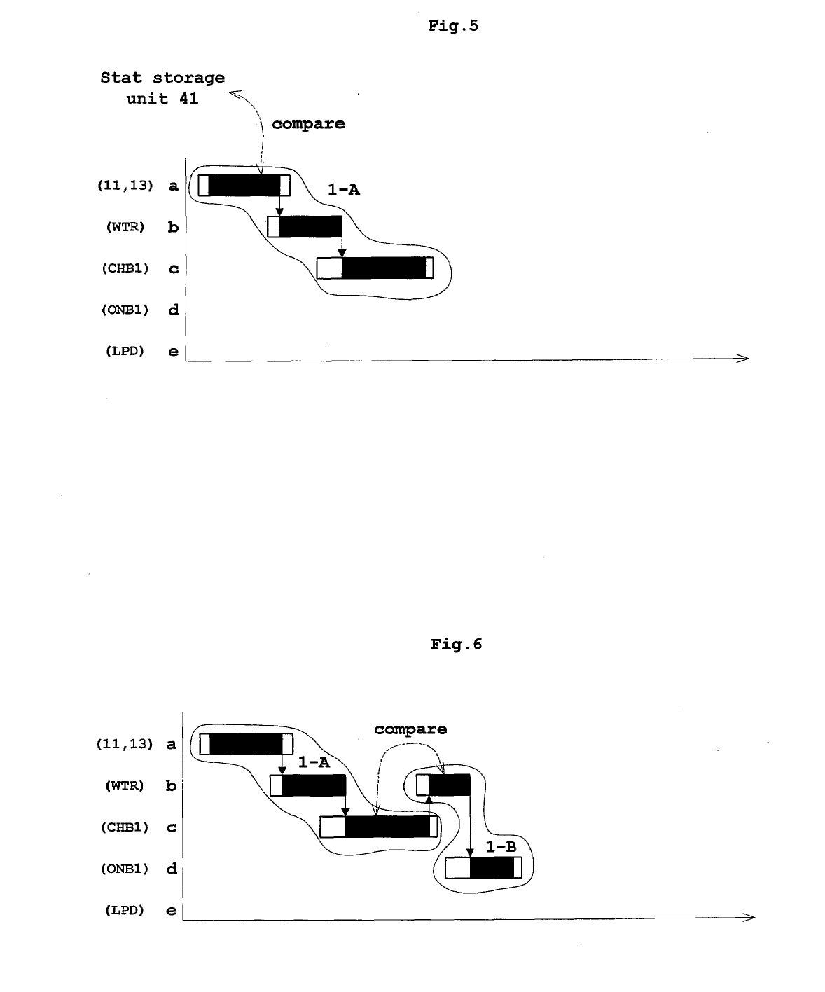

Next, a specific scheduling will be described with reference to FIGS. 4 through 8. FIG. 4 is a flow chart of operation. FIGS. 5 through 8 are time charts showing scheduling stages.

In the following description, the controller 31 prepares a schedule according to the recipe by regarding a plurality of treating steps as one block, taking an efficient allocation into consideration. As a specific example, as shown in FIGS. 5 through 8, loading and unloading by the first transport mechanism 11 and second transport mechanism 13 are regarded as treating step a, transportation by the third transport mechanism WTR as treating step b, chemical treatment by the chemical treating unit CHB1 as treating step c, rinsing treatment by the deionized water cleaning unit ONB1 as treating step d, and drying treatment by the drying unit LPD as treating step e. Block A is regarded as one including treating steps a-c, and block B regarded as one including treating steps b and d. As for the “number-alphabetic characters” in FIGS. 5 through 8, each number represents a lot under treatment, and each alphabetic character represents a block.

Steps S1 and S2

When there is a block to be scheduled, the scheduling unit 33 executes step S2 for searching a position for allocation. On the other hand, when there is no block to be scheduled, the operation is ended.

Step S3

The scheduling unit 33 allocates the block to be scheduled.

Specifically, as shown in FIG. 5, for example, block A for a first lot (reference 1-A) is allocated to in a position for allocation.

Step S4

The operation is branched according to whether a different block is present before or after block A.

Specifically, checking is made whether a different block is present temporally before or after block A allocated for the first lot (referenced 1-A). When there is a different block, the operation moves to step S5. Otherwise, the operation moves to step S6.

Step S6

Since there is no other block present before or after block A allocated for the first lot (referenced 1-A), whether or not the chuck 15 needs to receive the rinsing and drying treatment in the chuck cleaning unit CHCL is determined as follows.

The scheduling unit 33 refers to the state storage unit 41, and reads a final treating step corresponding to the origin of transportation by the third transport mechanism WTR before the start of scheduling. Whether dynamic processing is necessary is determined from the final treating step read, the treating step a (loading and unloading) corresponding to the origin of transportation of the current specific treating step and the table (FIG. 3) in the storage unit 39. Assume here that a loading and unloading step is stored in the state storage unit 41. This constitutes a comparison between two loading and unloading steps, and it can be determined from the table of FIG. 3 that no dynamic processing is necessary. Thus, the operation returns from step S6 to step S1.

The above process is repeated from step S1. Assume that, in steps S2 and S3, block B for the first lot is allocated as in FIG. 6 (referenced 1-B in FIG. 6). Then, since step S4 finds block A for the first lot already allocated before this block B, the operation will move to step S5.

Step S5

The scheduling unit 33 compares block B for the first lot (referenced 1-B in FIG. 6) and block A for the first lot (referenced 1-A in FIG. 6), and determines whether dynamic processing is necessary from the treating step a (loading and unloading) corresponding to the origin of transportation for the previous specific treating step, the treating step c (chemical treatment) corresponding to the origin of transportation for the current specific treating step and the table of FIG. 3. At this time, dynamic processing is determined unnecessary, and the operation returns to step S1.

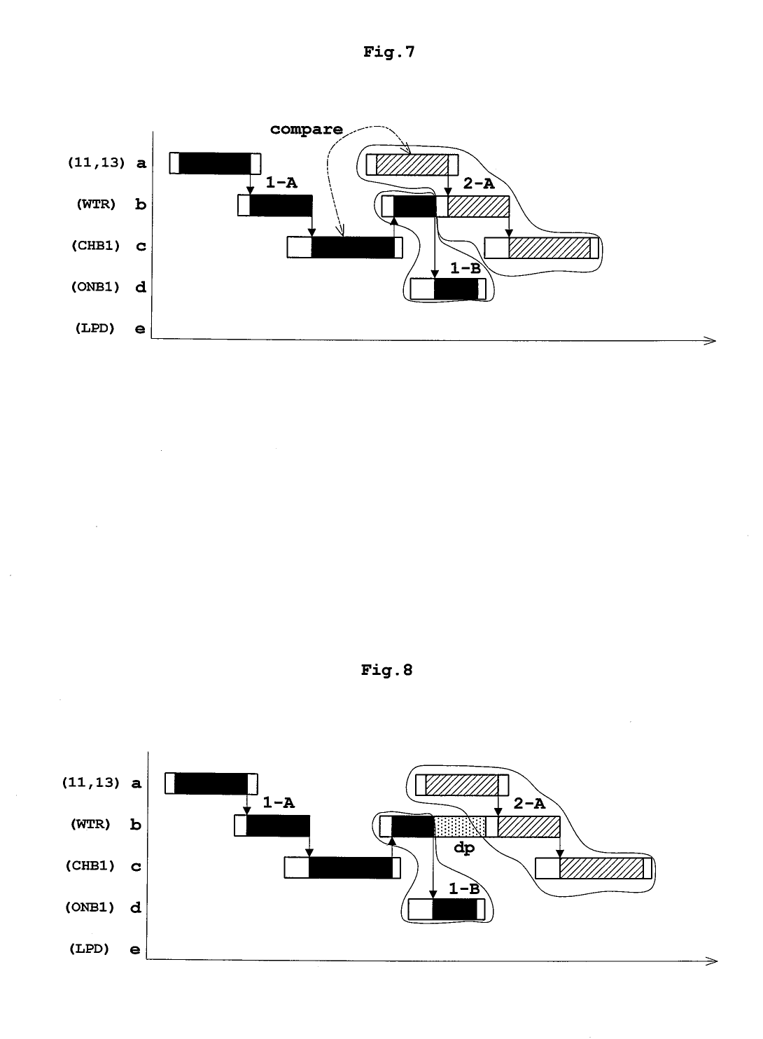

Next, the process is repeated from step S1 as noted above. Block A for a second lot is to be allocated as shown in FIG. 7 (referenced 2-A). Then, the operation moves from step S4 to step S5.

Step S5

Based on the treating step c (chemical treatment) corresponding to the origin of transportation for the previous specific treating step, the treating step a (loading and unloading) corresponding to the origin of transportation for the current specific treating step and the table of FIG. 3, the scheduling unit 33 determines whether dynamic processing should be inserted between block A for the second lot (referenced 2-A) and block B for the first lot (referenced 1-B). Here, dynamic processing is required, and the operation moves to step S7.

Step S7

The scheduling unit 33 allocates dynamic processing before the current specific treating step as shown in FIG. 8. That is, “rinsing and drying treatment” of the chuck 15 is allocated as dynamic processing dp before transportation which is treating step b in block A for the second lot (referenced 2-A).

Steps S8-S12

Block A for the second lot (referenced 2-A) is placed as treatment following the dynamic processing dp. At this time, when each block can be allocated to its original position, the operation returns to step S1 through steps S9 and S10. When each block cannot be allocated to the original position because of relations with other blocks, the dynamic processing is once deleted and a search is made for a position for allocation through steps S11 and S12. Then, the operation returns to step S1.

After a schedule is prepared as described above, this schedule is stored in the storage unit 39. The treatment instructing unit 37 executes an actual operation for treatment.

According to this embodiment, as described above, the controller 31, when allocating specific treating step b that may be accompanied by dynamic processing among treating steps, determines whether the rinsing and drying treatment which is dynamic processing should be allocated before the current specific treating step b, based on the combination of a treating step corresponding to the origin of transportation for the previous specific treating step b, a treating step corresponding to the origin of transportation for the current specific treating step b and the table of FIG. 3 (combinations of treating steps immediately preceding transporting operations). Thus, the dynamic processing is not arranged uniformly. The rinsing and drying treatment which is dynamic processing can be allocated flexibly according to an allocating situation of treating steps for different lots. A wasteful allocation of dynamic processing is eliminated, thereby securing improved throughput of the substrate treating apparatus.

As in allocating block A for the first lot, a proper decision can be made by referring to the storage unit 39, even when no previous specific treating step b is included in the schedule.

This invention is not limited to the foregoing embodiment, but may be modified as follows:

(1) In the foregoing embodiment, “dynamic processing” is exemplified by rinsing and drying treatment of the chuck 15 of the third transport mechanism WTR. In addition, dynamic processing may be a maintenance operation for returning to the origin position of the third transport mechanism WTR, which is performed in order to maintain the accuracy of position for transportation.

(2) In the foregoing embodiment, a determination is made by referring to the state storage unit 41 when no previous specific treating step is included in the schedule. Where the state storage unit 41 is not provided, dynamic processing may be carried out without exception.

(3) In the foregoing embodiment, the table shown in FIG. 3 is used for determination as a table of combinations of treating steps forming the origins of transportation. This invention is not limited to this table, but may use a different table for enabling appropriate determinations according to specific treating steps.

(4) In the foregoing embodiment, a plurality of treating steps are handled as one block for scheduling purposes. Instead, each treating step may be handled as one block.

This invention may be embodied in other specific forms without departing from the spirit or essential attributes thereof and, accordingly, reference should be made to the appended claims, rather than to the foregoing specification, as indicating the scope of the invention.

What is claimed is:

1. A scheduling method for a substrate treating apparatus having a plurality of treating sections for treating substrates, wherein, based on a recipe including a plurality of treating steps, a controller determines beforehand an order of treating a plurality of lots successively by operating a transport device having a substrate holder for transferring the substrates to transport the lots to the treating sections, said method comprising:
a step executed by said controller when arranging a specific treating step that may be accompanied by dynamic processing, among said treating steps, for determining whether the dynamic processing should be allocated before said specific treating step, based on a treating step corresponding to an origin of transportation for a previous specific treating step and a treating step corresponding to an origin of transportation for said specific treating step.

2. A method as defined in claim 1, wherein, absent said previous specific treating step, said controller refers to a state storage unit storing a final state of the substrate holder, and regards the final state of the substrate holder as the treating step corresponding to the origin of transportation for the previous specific treating step.

3. A method as defined in claim 1, wherein said dynamic processing is rinsing and drying treatment for cleaning with deionized water and drying the substrate holder.

4. A method as defined in claim 2, wherein said dynamic processing is rinsing and drying treatment for cleaning with deionized water and drying the substrate holder.

5. A method as defined in claim 1, wherein said controller allocates the dynamic processing when the treating step corresponding to the origin of transportation for the previous specific treating step is treatment with a chemical solution, and the treating step corresponding to the origin of transportation for said specific treating step is one of rinsing treatment of the substrates with deionized water, rinsing and drying treatment of the substrates, and loading or unloading of the substrates.

6. A method as defined in claim 2, wherein said controller allocates the dynamic processing when the treating step corresponding to the origin of transportation for the previous specific treating step is treatment with a chemical solution, and the treating step corresponding to the origin of transportation for said specific treating step is one of rinsing treatment of the substrates with deionized water, rinsing and drying treatment of the substrates, and loading or unloading of the substrates.

7. A method as defined in claim 3, wherein said controller allocates the dynamic processing when the treating step corresponding to the origin of transportation for the previous specific treating step is treatment with a chemical solution, and the treating step corresponding to the origin of transportation for said specific treating step is one of rinsing treatment of the substrates with deionized water, rinsing and drying treatment of the substrates, and loading or unloading of the substrates.

8. A method as defined in claim 4, wherein said controller allocates the dynamic processing when the treating step corresponding to the origin of transportation for the previous specific treating step is treatment with a chemical solution, and the treating step corresponding to the origin of transportation for said specific treating step is one of rinsing treatment of the substrates with deionized water, rinsing and drying treatment of the substrates, and loading or unloading of the substrates.

9. A method as defined in claim 1, wherein, absent a state storage unit storing a final state of the substrate holder, and absent the treating step corresponding to the origin of transportation for the previous specific treating step, said controller allocates the dynamic processing before said specific treating step.

10. A method as defined in claim 2, wherein, absent the state storage unit storing the final state of the substrate holder, and absent the treating step corresponding to the origin of transportation for the previous specific treating step, said controller allocates the dynamic processing before said specific treating step.

11. A scheduling program for a substrate treating apparatus having a plurality of treating sections for treating substrates, wherein, based on a recipe including a plurality of treating steps, a controller determines beforehand an order of treating a plurality of lots successively by operating a transport device having a substrate holder for transferring the substrates to transport the lots to the treating sections, said program comprising:
a process executed by said controller when arranging a specific treating step that may be accompanied by dynamic processing, among said treating steps, for determining whether the dynamic processing should be allocated before said specific treating step, based on a treating step corresponding to an origin of transportation for a previous specific treating step and a treating step corresponding to an origin of transportation for said specific treating step.

12. A program as defined in claim 11, wherein, absent said previous specific treating step, said controller refers to a state storage unit storing a final state of the substrate holder, and regards the final state of the substrate holder as the treating step corresponding to the origin of transportation for the previous specific treating step.

13. A program as defined in claim 11, wherein said dynamic processing is rinsing and drying treatment for cleaning with deionized water and drying the substrate holder.

14. A program as defined in claim 12, wherein said dynamic processing is rinsing and drying treatment for cleaning with deionized water and drying the substrate holder.

15. A program as defined in claim 11, wherein said controller allocates the dynamic processing when the treating step corresponding to the origin of transportation for the previous specific treating step is treatment with a chemical solution, and the treating step corresponding to the origin of transportation for said specific treating step is one of rinsing treatment of the substrates with deionized water, drying treatment of the substrates, and loading or unloading of the substrates.

16. A program as defined in claim 12, wherein said controller allocates the dynamic processing when the treating step corresponding to the origin of transportation for the previous specific treating step is treatment with a chemical solution, and the treating step corresponding to the origin of transportation for said specific treating step is one of rinsing treatment of the substrates with deionized water, drying treatment of the substrates, and loading or unloading of the substrates.

17. A program as defined in claim 13, wherein said controller allocates the dynamic processing when the treating step corresponding to the origin of transportation for the previous specific treating step is treatment with a chemical solution, and the treating step corresponding to the origin of transportation for said specific treating step is one of rinsing treatment of the substrates with deionized water, drying treatment of the substrates, and loading or unloading of the substrates.

18. A program as defined in claim 14, wherein said controller allocates the dynamic processing when the treating step corresponding to the origin of transportation for the previous specific treating step is treatment with a chemical solution, and the treating step corresponding to the origin of transportation for said specific treating step is one of rinsing treatment of the substrates with deionized water, drying treatment of the substrates, and loading or unloading of the substrates.

19. A program as defined in claim 11, wherein, absent a state storage unit storing a final state of the substrate holder, and absent the treating step corresponding to the origin of transportation for the previous specific treating step, said controller allocates the dynamic processing before said specific treating step.

20. A program as defined in claim 12, wherein, absent the state storage unit storing the final state of the substrate holder, and absent the treating step corresponding to the origin of transportation for the previous specific treating step, said controller allocates the dynamic processing before said specific treating step.
